(19) United States
(12) Patent Application Publication
(10) Pub. No.: US 2013/0233943 A1
(43) Pub. Date: Sep. 12, 2013

(54) BOTTLE FOR USE WITH A SPRAY GUN

(71) Applicant: BRIGGS & STRATTON CORPORATION, Wauwatosa, WI (US)

(72) Inventors: Paul Anthony Janik, Saukville, WI (US); Michael Madden, Shorewood, WI (US)

(73) Assignee: BRIGGS & STRATTON CORPORATION, Wauwatosa, WI (US)

(21) Appl. No.: 13/787,517

(22) Filed: Mar. 6, 2013

Related U.S. Application Data
(60) Provisional application No. 61/607,362, filed on Mar. 6, 2012.

(51) Int. Cl. B05B 15/06

(52) U.S. Cl. CPC B05B 15/065
USPC 239/302; 215/40; 215/44

(57) ABSTRACT

A bottle for use with a spray gun includes a bottle body defining a storage volume; a throat extending away from the bottle body, a first attachment portion, and a second attachment portion. The throat defines an opening to the storage volume, and includes a narrow portion and a wide portion located between the narrow portion and the bottle body. The first attachment portion is formed at the narrow portion and is configured to be attached to a spray gun. The second attachment portion is formed at the wide portion and is configured to be attached to a cap to close the bottle body.

### CROSS-REFERENCE TO RELATED PATENT APPLICATIONS

This application claims the benefit of U.S. Provisional Application No. 61/607,362, filed Mar. 6, 2012, which is incorporated herein by reference in its entirety.

### BACKGROUND

The present application relates to a bottle for holding a liquid, and more particularly to a bottle having both quick-connect tabs and a threaded cap connector for use with a liquid spray gun.

The use of spray guns for cleaning and other tasks is well known. These spray guns typically attach to a water supply to provide a water spray of differing pressures, dependent upon the desired task. Spray guns have been designed to accommodate liquid chemical bottles thereon, wherein a liquid chemical is introduced into the water stream prior to exiting the spray gun. This liquid chemical may be a detergent for cleaning various surfaces, a fertilizer for lawn care, a pesticide, an herbicide, etc. The liquid chemical bottle is either threaded onto the spray gun or affixed to the spray gun via a plurality quick-connect tabs. In order to utilize a different chemical within the bottle, the user must dispose of any unused chemical within the bottle and refill the bottle with their chemical of choice. That is, the user cannot easily switch chemicals for use with the spray gun, while also preserving unspent chemicals for future applications.

### SUMMARY

One embodiment of the invention relates to a bottle for use with a spray gun. The bottle includes a bottle body defining a storage volume; a throat extending away from the bottle body, a first attachment portion, and a second attachment portion. The throat defines an opening to the storage volume, and includes a narrow portion and a wide portion located between the narrow portion and the bottle body. The first attachment portion is formed at the narrow portion and is configured to be attached to a spray gun. The second attachment portion is formed at the wide portion and is configured to be attached to a cap to close the bottle body.

Another embodiment of the invention relates to a spray gun system. The spray gun system includes a spray gun including a bottle attachment portion for attaching a bottle to the spray gun, a cap including a bottle attachment portion for attaching the cap to a bottle, and a bottle. The bottle includes a bottle body defining a storage volume, a throat extending away from the bottle body. The throat defines an opening to the storage volume. The throat includes a narrow portion and a wide portion located between the narrow portion and the bottle body. The bottle further includes a a first attachment portion and a second attachment portion. The first attachment portion is formed at the narrow portion attaches to the bottle attachment portion of the spray gun. The second attachment portion is formed at the wide portion and is attaches to the bottle attachment portion of the cap to close the bottle body.

Another embodiment of the invention relates to a bottle for use with a spray gun. The bottle includes a bottle body defining a storage volume and a throat extending away from the bottle body. The throat defines an opening to the storage volume. The throat includes a first attachment portion for attaching the bottle to a spray gun. The throat also includes a second attachment portion for attaching a cap to the bottle to close the bottle body.

Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, in which:

FIG. 1 is a top view of a liquid chemical bottle, in accordance with an exemplary embodiment.

FIG. 2 is a perspective view of the liquid chemical bottle of FIG. 1.

FIG. 3 is a side view of the liquid chemical bottle of FIG. 1.

FIG. 4 is a front view of the liquid chemical bottle of FIG. 1.

FIG. 5 is a side view of a liquid chemical bottle with a cap coupled to the bottle, in accordance with an exemplary embodiment.

FIG. 6 is a cross-section view of the cap coupled to the throat of the liquid chemical bottle of FIG. 5, taken along line 6-6.

FIG. 7 is a side view of a liquid chemical bottle, in accordance with another exemplary embodiment.

FIG. 8 is a perspective view of the liquid chemical bottle of FIG. 7.

FIG. 9 is a side view of a spray gun and liquid chemical bottle system, in accordance with an exemplary embodiment.

FIG. 10 is a partial cross-section view of a liquid chemical bottle coupled to a spray gun with a quick connect mechanism, in accordance with an exemplary embodiment.

FIG. 11 is a detail cross-section view of the quick connect mechanism of FIG. 10, in accordance with an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

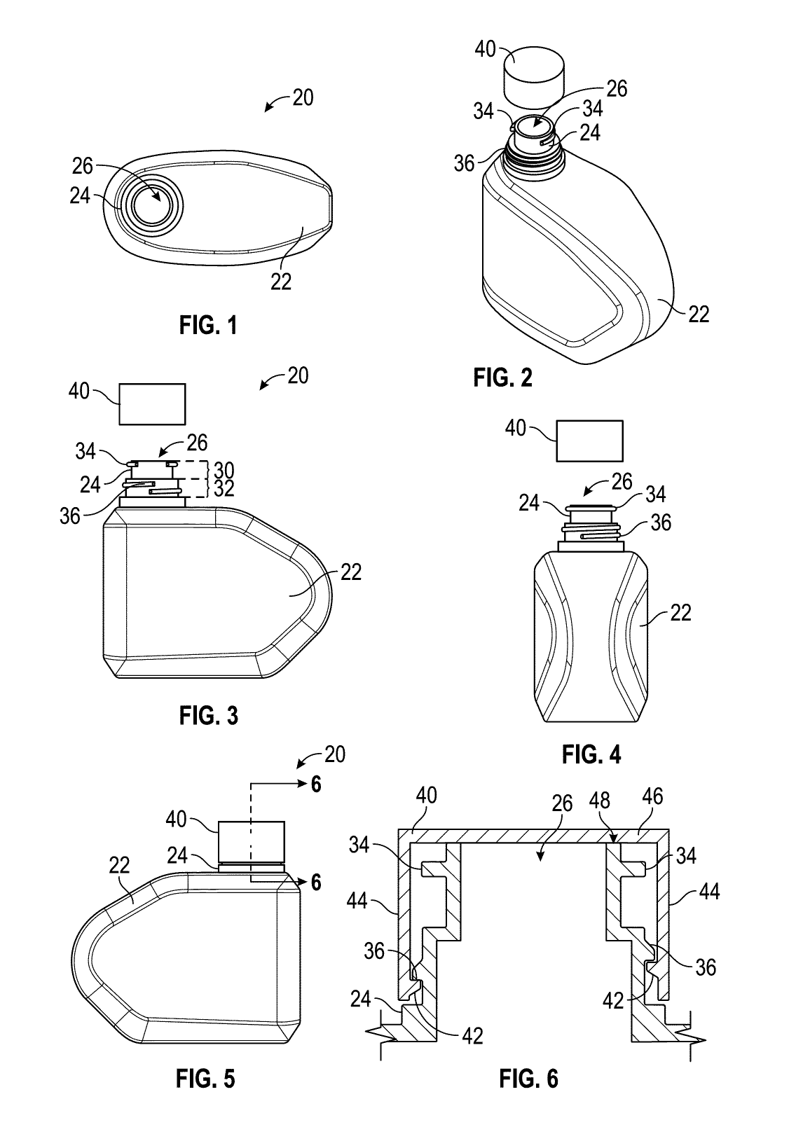

Referring in general to FIGS. 1-11, a liquid chemical bottle and a spray system using the chemical bottle are shown with both a quick-connect assembly for easy on-off application of the bottle to a spray gun and a secure, resealable cap to allow for storage of any unused chemicals in the bottle for future use. The multiple connections allow for a system of liquid chemical bottles containing different chemicals to be used with a spray gun to avoid constant refilling and chemical waste. Alternatively, the bottle and cap system described below can be used with a bottle that attaches to a pressure washer or other piece of equipment rather than, or in addition to, a spray gun.

Referring to FIGS. 1-4, a liquid chemical bottle 20 is shown according to an exemplary embodiment. The bottle 20 includes a hollow body 22 defining an internal storage volume capable of containing a liquid. The bottle 20 further includes a throat 24 (e.g., neck, spout, etc.) extending away from the bottle body 22. The throat 24 opens into the storage volume of the body 22 and defines an opening 26. Liquid contained in the bottle body 22 may be emptied from the body 22 through the opening 26. The opening 26 may be closed by a seal (e.g., a foil seal, tamper evident seal etc.). The seal may be broken by a user to clear the opening 26 and allow the liquid chemical to be emptied from the body 22.

According to an exemplary embodiment, the throat 24 is a generally cylindrical body. The throat 24 includes a narrow portion 30 proximate to the opening 26 and a wide portion 32 located between the narrow portion 30 and the bottle body 22. The outside diameter of the narrow portion 30 is smaller than the outside diameter of the wide portion 32. A first attachment portion, shown as tabs 34, are formed at the narrow portion 30. The tabs 34 are configured to couple the bottle 20 to a device via a quick-connect mechanism (e.g., via a simple quarter-turn rotation by a user). A second attachment portion, shown as threads 36, are formed at the wide portion 32. The threads 36 do not act as a coupling mechanism between the bottle 20 and the device. Instead, the threads 36 are configured to couple the bottle 20 to a threaded cap 40 (e.g., cover, lid, closure, etc.). The cap 40 seals the opening 26 to retain a liquid in the body 22 when the bottle 20 is not coupled to the device.

Referring now to FIGS. 5-6, the liquid chemical bottle 20 is shown coupled to the cap 40. The cap 40 may be a low-cost, conventional threaded cap. The cap 40 fits over the throat 24 to rotationally engage threads 36 on the wide portion 32 with corresponding internal threads 42. Because the diameter of the wide portion 32 is greater than the diameter of the narrow portion 30, the threads 42 are able to pass over the tabs 34 without engaging the tabs 34 and a clearance is maintained between the tabs 34 and the sidewall 44 of the cap 40. In some embodiments, an inner surface of the cap 40 forms a seal with the throat 24 to seal the bottle 20. According to an exemplary embodiment, the inner surface of the end wall 46 of the cap 40 abuts against the top surface 48 of throat 24 surrounding the opening 26 when the cap 40 is fully threaded onto the bottle 20. The cap 40 therefore prevents the flow of liquid out of the opening 26 and effectively seals the liquid within the bottle 20.

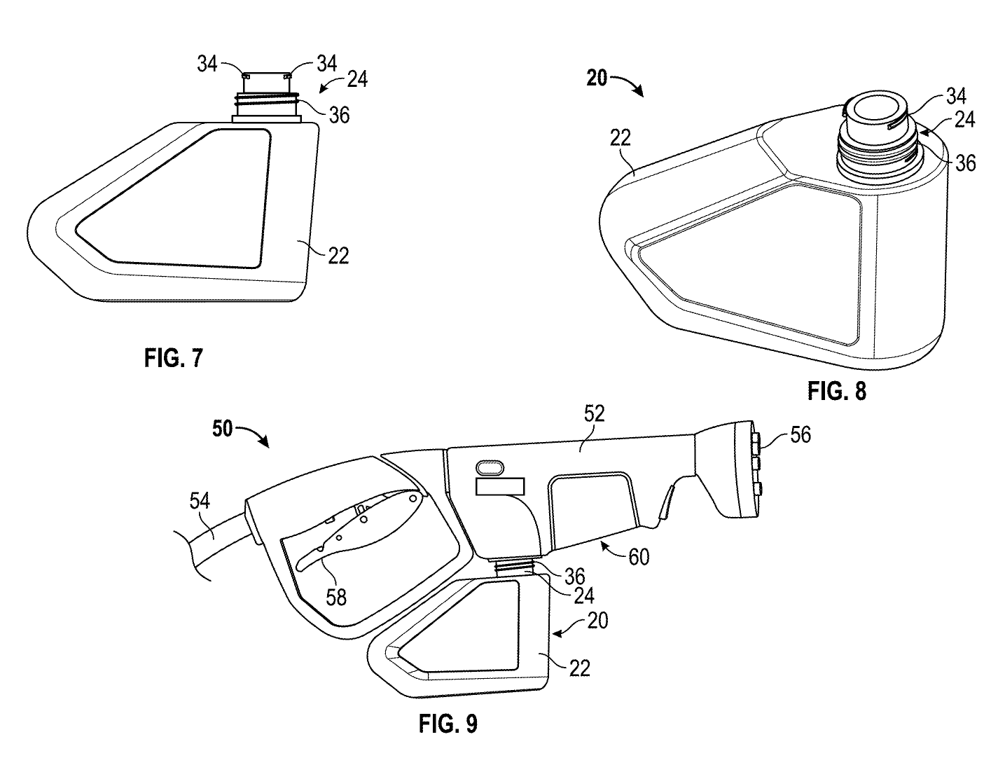

As shown in FIGS. 7-8, in some embodiments, the bottle 20 is differently shaped. In some embodiments, differently shaped bottles are used to identify the chemical stored in the bottle. For example, a bottle storing soap may have a different shape than a bottle storing polish so that the user can easily identify the bottle needed to perform a desired task.

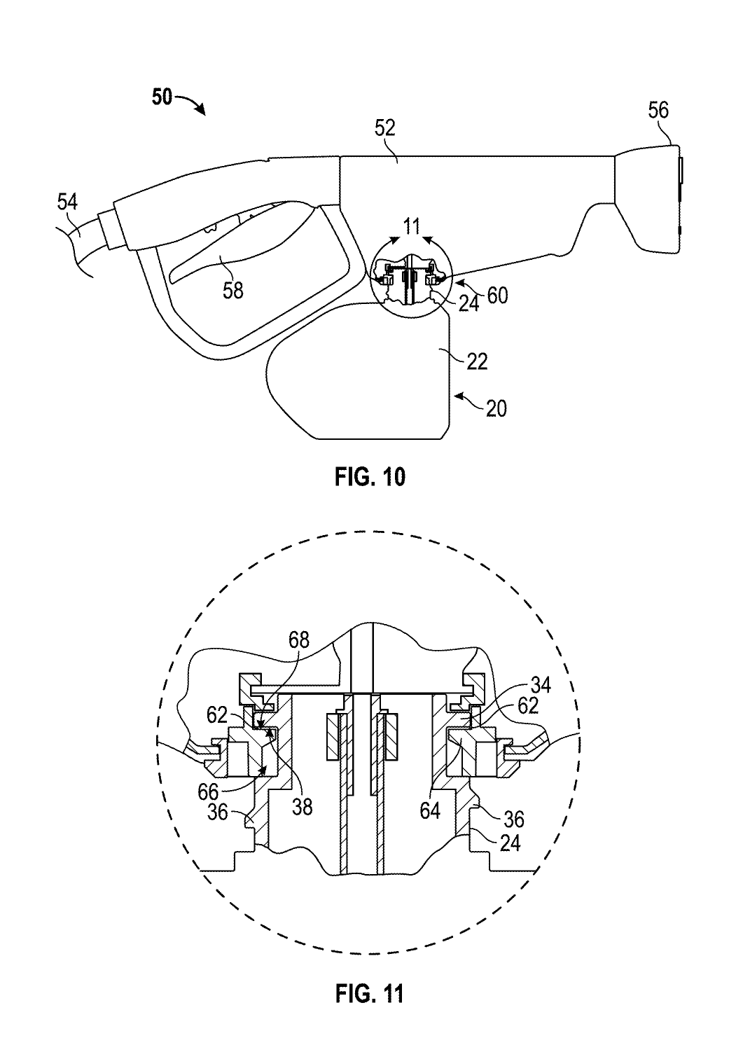

Referring now to FIGS. 9-11, a spray gun system 50 including the bottle 20 coupled to a spray gun 52 is shown according to an exemplary embodiment. The spray gun 52 receives water or another liquid through a supply line 54. The spray gun 56 emits the water or other liquid through a nozzle 56 in various spray patterns. A trigger 58 is utilized to start and stop the flow of water or other liquid out of nozzle 56. The spray gun 52 further includes a bottle attachment portion, shown as a connection mechanism 60. The connection mechanism 60 allows for a secure connection between the bottle 20 and the spray gun 52. Referring to FIGS. 10-11, according to an exemplary embodiment, the connection mechanism 60 is a quick-connect mechanism including internal slots 62 formed by an inwardly extending flange 64. The flange 64 defines an aperture 66 (e.g., socket, hollow, opening, etc.). To connect the bottle 20 to the spray gun 52, the throat 24 is inserted into the aperture 66 with the tabs 34 passing through openings in the flange 64 until the tabs 34 are aligned with the slots 62. The bottle 20 may then be turned less than 360° to move the tabs 34 within the slots 62 away from the openings in the flange 66. The lower surfaces 38 of the tabs 34 engage the upper surface 68 of the flange 64 to couple the bottle 20 to the spray gun 52. According to an exemplary embodiment, the connection mechanism 60 couples the bottle 20 to the spray gun 52 with a quarter or 90° turn. The threads 36 are not engaged by the connection mechanism 60 when the bottle 20 is coupled to the spray gun 52. Instead, the threads 36 remain outside of the connection mechanism 60 and the interior of the spray gun 52.

A liquid chemical from within bottle body 22 is introduced into the water stream of spray gun 52 via an input hose 70 extending into the internal volume of the body 22 such that the end of the hose 70 is submerged in the liquid chemical. The liquid chemical is dawn through the input hose and is included in the liquid expelled from nozzle 54 during use.

A primary advantage to constructing bottle 20 to have both tabs 34 for a quick-connect coupling and threads 36 is to enable the bottle to both be quickly and easily coupled and decoupled from a device such as the spray gun 52, while still allowing a conventional threaded cap 40 to be removeably coupled to the bottle 20, sealing the opening 26. A bottle partially filled with liquid chemicals may therefore be sealed with a cap and stored until needed again. The unused liquid chemicals may therefore remain in the bottle without having to empty the liquid contents from bottle after each use. Due to this advantage, it is envisioned that a spray gun system may include (or offer as an option) multiple liquid chemical bottles, with each bottle containing a different liquid chemical for a variety of tasks utilizing the spray gun. For example, any number of separate bottles containing a liquid detergent, a polish, a liquid fertilizer, a liquid herbicide, and a liquid pesticide could be offered to a user as a package. Each of the bottles may be resealable via a cap and may be meant to contain only the liquid originally present therein. A user of the spray gun system, when wanting to alternate between tasks using the spray gun, may change the chemical being added to the water stream from the spray gun by disconnecting a first, existing liquid chemical bottle from the spray gun, sealing the first bottle with a cap, and attaching a second, replacement liquid chemical bottle to the spray gun appropriate for their desired task. By using multiple bottle, with each bottle dedicated for use with a single chemical, a single bottle does not need to be filled or emptied, and cross-contamination between bottle contents can be avoided. While several examples of liquid chemicals are given above, the present invention is not limited to such chemicals and may include any appropriate or desired chemical.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. A bottle for use with a spray gun, comprising:
a bottle body defining a storage volume;
a throat extending away from the bottle body, wherein the throat defines an opening to the storage volume, and wherein the throat includes a narrow portion and a wide portion located between the narrow portion and the bottle body;
a first attachment portion formed at the narrow portion, wherein the first attachment portion is configured to be attached to a spray gun; and
a second attachment portion formed at the wide portion, wherein the second attachment portion is configured to be attached to a cap to close the bottle body.

2. The bottle of claim 1, wherein the first attachment portion comprises a quick-connect coupling; and
wherein the second attachment portion comprises a threaded coupling.

3. The bottle of claim 2, wherein the quick-connect coupling comprises a plurality of quick-connect tabs extending from the narrow portion and the quick-connect tabs are configured to attach the bottle to the spray gun via a less than 360-degree rotation of the bottle.

4. The bottle of claim 3, wherein the less than 360-degree rotation of the bottle is a quarter-turn rotation of the bottle.

5. The bottle of claim 4, wherein the narrow portion has a first outside diameter and the wide portion has a second outside diameter greater than the first outside diameter.

6. The bottle of claim 5, further comprising:
a cap including a threaded coupling, wherein the threaded coupling of the cap attaches the cap to the second attachment portion.

7. The bottle of claim 1, wherein the narrow portion has a first outside diameter and the wide portion has a second outside diameter greater than the first outside diameter.

8. The bottle of claim 1, further comprising:
a cap including a bottle attachment portion for attaching the cap to the second attachment portion of the bottle.

9. A spray gun system, comprising:
a spray gun including a bottle attachment portion for attaching a bottle to the spray gun;
a cap including a bottle attachment portion for attaching the cap to a bottle; and
a bottle including,
a bottle body defining a storage volume,
a throat extending away from the bottle body, wherein the throat defines an opening to the storage volume, and wherein the throat includes a narrow portion and a wide portion located between the narrow portion and the bottle body,
a first attachment portion formed at the narrow portion, wherein the first attachment portion attaches to the bottle attachment portion of the spray gun, and
a second attachment portion formed at the wide portion, wherein the second attachment portion attaches to the bottle attachment portion of the cap to close the bottle body.

10. The spray gun system of claim 9, wherein the bottle attachment portion of the spray gun comprises a quick-connect coupling;
wherein the first attachment portion comprises a quick-connect coupling; and
wherein the second attachment portion comprises a threaded coupling.

11. The spray gun system of claim 10, wherein the quick-connect coupling of the spray gun comprises a plurality of slots; and
wherein the quick-connect coupling of bottle comprises a plurality of quick-connect tabs extending from the narrow portion and the quick-connect tabs are received by the slots to attach the bottle to the spray gun via a less than 360-degree rotation of the bottle.

12. The spray gun system of claim 11, wherein the less than 360-degree rotation of the bottle is a quarter-turn rotation of the bottle.

13. The spray gun system of claim 12, wherein the narrow portion has a first outside diameter and the wide portion has a second outside diameter greater than the first outside diameter.

14. The spray gun system of claim 9, wherein the narrow portion has a first outside diameter and the wide portion has a second outside diameter greater than the first outside diameter.

15. A bottle for use with a spray gun, the bottle comprising:
a bottle body defining a storage volume; and
a throat extending away from the bottle body, wherein the throat defines an opening to the storage volume, and wherein the throat includes a first attachment portion for attaching the bottle to a spray gun, and wherein the throat also includes a second attachment portion for attaching a cap to the bottle to close the bottle body.

16. The bottle of claim 15, wherein the first attachment portion has a first outside diameter and the second attachment portion has a second outside diameter greater than the first outside diameter.

17. The bottle of claim 15, wherein the first attachment portion comprises a quick-connect coupling; and
wherein the second attachment portion comprises a threaded coupling.

18. The bottle of claim 17, wherein the quick-connect coupling comprises a plurality of outwardly-extending quick-connect tabs and the quick-connect tabs attach the bottle to the spray gun via a less than 360-degree rotation of the bottle.

19. The bottle of claim 18, wherein the less than 360-degree rotation of the bottle is a quarter-turn rotation of the bottle.

20. The bottle of claim 19, further comprising:
a cap including a threaded coupling, wherein the threaded coupling of the cap attaches the cap to the threaded coupling of the throat.
